(19) United States
(12) Patent Application Publication
(10) Pub. No.: US 2010/0138302 A1
(43) Pub. Date: Jun. 3, 2010

(54) UE AND ADVERTISEMENT SERVICE SERVER FOR BIDIRECTIONAL PERSONALIZED ADVERTISEMENT, AND BIDIRECTIONAL PERSONALIZED ADVERTISEMENT METHOD

(76) Inventors: Il-kyun Park, Seoul (KR); Kyung-hun Kim, Gwangju-si (KR); Jai-sang Koh, Gwangju-si (KR); Byung-tak Lee, Suwon-si (KR); Seung-hun Oh, Gwangju-si (KR); Nac-woo Kim, Gwangju-si (KR); Hong-yeon Yu, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/572,152

(22) Filed: Oct. 1, 2009

(30) Foreign Application Priority Data
Nov. 28, 2008 (KR) 10-2008-0119450

(51) Int. Cl. G06Q 30/00

(52) U.S. Cl. 705/14.58; 705/14.66

(57) ABSTRACT

A user equipment and an advertisement service server for a bidirectional personalized advertisement, and a bidirectional personalized advertisement method are provided. The UE receives user setting information and advertisement meta-information from the advertisement service server, stores the received user setting information and advertisement meta-information, searches for advertisement contents corresponding to the user setting information from the stored advertisement meta-information and selects the found advertisement contents when an advertisement event occurs, and displays the selected advertisement contents. Accordingly, the dependence of an online advertisement service on a particular media service can be prevented.

### CROSS REFERENCE TO RELATED APPLICATION

This application claims the benefit under 35 U.S.C. §119(a) of Korean Patent Application No. 10-2008-0119450, filed on Nov. 28, 2008, the disclosure of which is incorporated by reference in its entirety for all purposes.

### BACKGROUND

1. Field

The following description relates to an online advertisement technology, and more particularly, to a user equipment (UE) and an advertisement service server for a bidirectional personalized advertisement and a method of providing a bidirectional personalized advertisement in the UE.

2. Description of the Related Art

An online advertisement service is one of the most profitable supplementary services for media service providers, such as Internet protocol television (IPTV) providers. However, the application of an online advertisement service is generally limited. Since a system for an online advertisement service is implemented with respect to a specific media service, high costs would be incurred to re-apply the system to a different media service.

In addition, once a system for an online advertisement service has been completed, it is difficult to reflect requirements for a new supplementary function in the system. Also, an online advertisement service cannot easily utilize media content information and user information necessary for a personalized service.

Information is in a form dependent on a specific media service, and thus high costs are required to obtain information independently and the obtained information needs to be processed in order to be compatible with the advertisement service.

Therefore, to overcome such drawbacks, an online advertisement technology has been developed, which is not dependent on the type of media service used, promotes development of composite advertisement service models in combination with various existing IP network-based services and allows advertisers to provide personalized advertisement to a more specific target audience by utilizing IP network subscriber information and media meta-information of a media service.

### SUMMARY

Accordingly, in one aspect, there is provided a personalized online advertisement technology which can prevent dependence on a particular media service.

Also, in another aspect, there is provided a personalized online advertisement in combination with various existing Internet protocol (IP) network-based services for more specific target users.

In one general aspect, there is provided a user equipment (UE) for bidirectional personalized advertisement, which receives user setting information and advertisement meta-information from an advertisement service server, stores the received user setting information and advertisement meta-information, searches for advertisement contents from the stored advertisement meta-information and selects the found advertisement contents when an advertisement event occurs, and displays the selected advertisement contents.

When the advertisement contents corresponding to the user setting information are searched from the advertisement meta-information, user request information or user location information may be further taken into account.

In another general aspect, there is provided an advertisement service server for bidirectional personalized advertisement, which stores and registers user setting information, advertisement meta-information, and advertisement contents from an advertiser terminal and transmits at least one of the user setting information, advertisement meta-information, and advertisement contents to a user equipment (UE) in real time or in non-real time.

Accordingly, a personalize advertisement is selected based on the advertisement meta-information and the user setting information, so that the dependence of an online advertisement service on a particular media service can be prevented.

Moreover, according to the exemplary embodiments, composite advertisement service models in combination with various existing IP network-based services can be developed, and advertisers are allowed to provide personalized advertisement to a more specific target audience by utilizing IP network subscriber information and media meta-information of a media service.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an advertisement service system for providing a bidirectional personalized advertisement.

FIG. 2 is a block diagram illustrating a UE for bidirectional personalized advertisement according to an exemplary embodiment.

FIG. 3 is a table showing an example of user setting information.

FIG. 4 is a table showing an example of advertisement meta-information.

FIG. 5 is a list showing an example of advertisement filtering information for advertisement selection.

FIG. 6 is a block diagram illustrating an advertisement service server for bidirectional personalized advertisement according to an exemplary embodiment.

FIG. 7 is a flowchart illustrating a bidirectional personalized advertisement method of a UE.

FIG. 8 is a flowchart illustrating procedures of providing user setting information to a UE from the advertisement service server via an IMS network.

FIG. 9 is a flowchart illustrating procedures of providing advertisement meta-information to the UE from the advertisement service server via the IMS network.

FIG. 10 is a flowchart illustrating procedures of receiving advertisement meta-information by a UE from the advertisement service server.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, a detailed description of known functions and configurations incorporated herein will be omitted when it may obscure the subject matter with unnecessary details.

Before describing the exemplary embodiments, a term used throughout this specification is defined. This term is defined in consideration of functions according to exemplary embodiments, and can be varied according to a purpose of a user or manager, or precedent and so on. Therefore, definitions of the term should be made on the basis of the overall context.

A bidirectional personalized advertisement is a user adaptive advertisement content selected based on advertisement meta-information and user setting information.

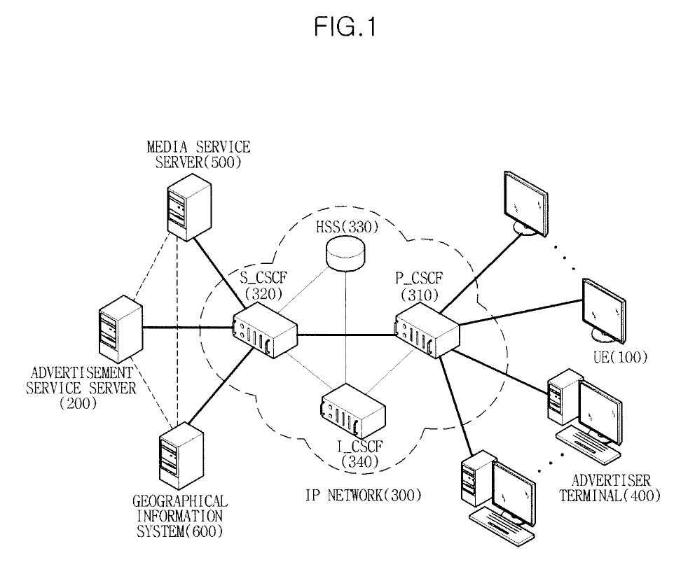

FIG. 1 is a diagram illustrating an advertisement service system for providing a bidirectional personalized advertisement. The advertisement service system includes a plurality of user equipments (UEs) 100 which receive a bidirectional personalized advertisement, an advertisement service server 200 which provides the bidirectional personalized advertisement, and an Internet protocol network 300. The plurality of UEs 100 and the advertisement service server 200 are connected to the IP network 300, and the bidirectional personalized advertisement is provided from the advertisement service server 200 to each of the UEs 100 via the IP network 300 in real time or non-real time.

The bidirectional personalized advertisement provided by the advertisement service server 200 is registered by an advertiser terminal 400, and information may be obtained from a media service server 500 in order to provide a composite advertisement service associated with IP network-based services.

For example, the IP network 300 may employ an IP multimedia subsystem (IMS) network which is specified by an international standardization organization, 3^{rd} Generation Partnership Project (3GPP), for the purpose of providing multimedia session control and service based on session initiation protocol (SIP) among all IP networks. An IMS network is a core network for providing an integrated service in the wired/wireless multi-access network environment.

The UEs 100 are connected to a proxy cell session control function (P-CSCF) 310 that acts as an initial access point for the UEs in the IMS network, and the advertisement service server 200 is connected to a serving call session control function (S-CSCF) 320, which performs SIP registration, controls and manages a session for a registered user and interworks with service platforms in order to provide various kinds of services.

In FIG. 1, a home subscriber server (HSS) 330 manages a service profile for subscriber registration and service providing. Information managed by the HSS 330 may be provided to the advertisement service server 200 to use as user setting information.

The advertisement service system includes an interrogating call session control function (I-CSCF) 340 that acts as an access point of an operator network and as a topology hiding inter-network gateway (THIG) in order to protect its own path information in the case of interworking with another operator network.

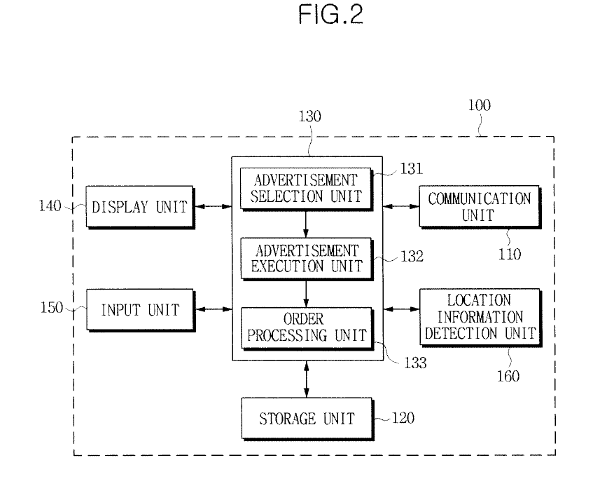

FIG. 2 is a block diagram illustrating a UE 100 for bidirectional personalized advertisement according to an exemplary embodiment. As shown in FIG. 2, the UE 100 includes a communication unit 110, a storage unit 120, a control unit 130, and a display unit 140.

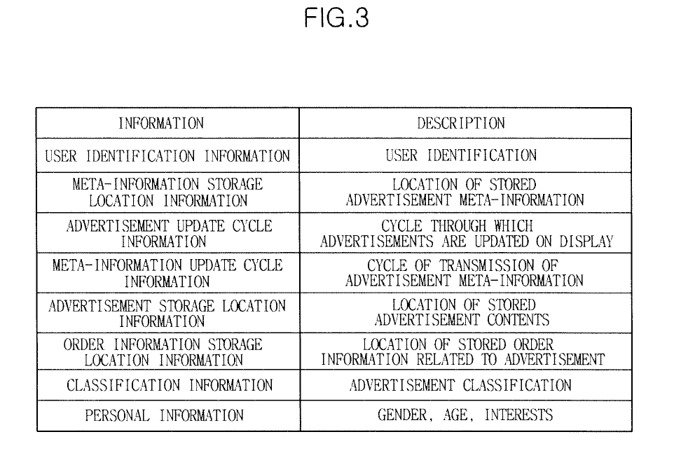

The communication unit 110 receives user setting information and advertisement meta-information from the advertisement service server 200 (referring to FIG. 1). The user setting information is generated based on information input into the advertisement service server 200 by a user who accesses the advertisement service server 200 using the UE 100 or subscriber information registered on the IP network, and may be configured as shown in FIG. 3.

FIG. 3 is a table showing an example of user setting information. Referring to FIG. 3, for example, the user setting information may contain user identification information, meta-information storing location information that indicates where the advertisement meta-information is stored, advertisement update cycle information that indicates a cycle of updating advertisement on a display, meta-information update cycle information that indicates a cycle of transferring the advertisement meta-information, advertisement storing location information that indicates where the advertisement is stored, classification information that specifies to which category the advertisement belongs, and personal information which shows the gender, the age, and interests of a user.

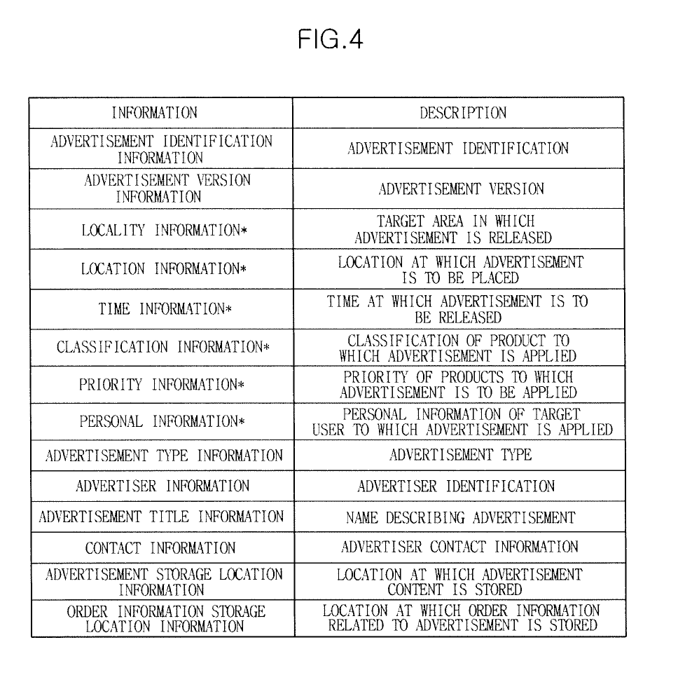

The advertisement meta-information is information related to an advertisement registered by the advertiser, and may be configured as shown, for example, in FIG. 4.

FIG. 4 is a table showing an example of advertisement meta-information. The meta-information contains advertisement identification information, advertisement version information, locality information indicating a target area in which the advertisement is released, location information indicating a location where the advertisement is displayed, time information indicating a time at which the advertisement is displayed, and classification information indicating a category of objects for which the advertisement is produced, priority information indicating a priority of objects to which the advertisement is applied, personal information of a target user of the advertisement, advertisement type information, advertiser identification information, advertisement title information describing the advertisement, contact information of the advertiser, advertisement storing location information, and order information storing location information indicating a location where order information for the advertisement is stored. In FIG. 4, pieces of information with an asterisk ‘*’ are used for personalized advertisement selection.

The storage unit 120 stores the user setting information and the advertisement meta-information received by the communication unit 110. The storage unit 120 may physically or logically distribute and store the user setting information and advertisement meta-information.

The control unit 130 controls the apparatus, and includes an advertisement selection unit 131. When an advertisement event occurs, the advertisement selection unit 131 selects advertisement contents corresponding to user setting information found from the advertisement meta-information stored in the storage unit 120.

For example, the advertisement event may be an advertisement request from a user, or an advertisement request automatically generated due to the use of a web service or a media service.

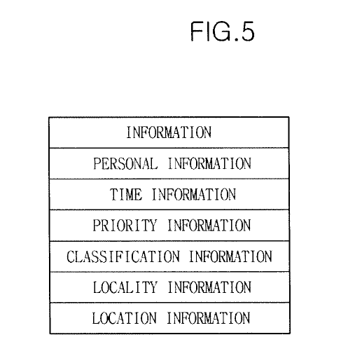

The advertisement selection unit 131 may generate advertisement filtering information as shown in FIG. 5 based on the user setting information as shown in FIG. 3. FIG. 5 is a list showing an example of advertisement filtering information for advertisement selection. The advertisement filtering information may contain personal information such as the age, the gender, and interests of a user which can be obtained from the user setting information, user requests such as time information, priority information, and classification information, which is obtained from user request information which will be described later, media meta-information, locality information and location information which may be detected from global information system (GIS) information and global positioning system (GPS) information.

The advertisement selection unit 131 compares the advertisement filtering information as shown in FIG. 5 with the advertisement meta-information configured as shown in FIG. 4 to search for personalized advertisement contents corresponding to the user setting information, and then selects the found personalized advertisement contents. The selected advertisement contents may be identified based on the advertisement identification information, the advertisement version information and the advertisement storage location information, each included in the advertisement meta-information.

The display unit 140 displays the advertisement contents selected by the advertisement selection unit 131. For example, the display unit 140 may be a liquid crystal display (LCD) to display advertisement content.

As described above, the UE selects personalized advertisement contents based on the advertisement meta-information and the user setting information, thereby avoiding a dependence of online advertisement services on a particular media service.

In one general aspect, referring to FIG. 2 again, the control unit 130 may include an advertisement execution unit 132. The advertisement execution unit 132 controls the advertisement contents corresponding to the user setting information selected by the advertisement selection unit 131 to be displayed on the display unit 140.

The advertisement execution unit 132 requests the advertisement service server 200 for real-time transmission of the advertisement contents selected by the advertisement selection unit to 131, and receives the advertisement contents and displays the received advertisement contents on the display unit 140 in real time.

Alternatively, the advertisement execution unit 132 may read out the advertisement contents selected by the advertisement selection unit 131 from the storage unit 120 and display the advertisement contents on the display unit 140 in non-real time.

Thus, the UE for the bidirectional personalized advertisement according to the exemplary embodiment can provide a user in real time or in non-real time with personalized advertisement contents which are not dependent on a particular media service.

In another general aspect, the control unit 130 may include an order processing unit 133. The order processing unit 133 requests the advertisement service server 200 for a user interface (UI) allowing the user to input order information for a product corresponding to the advertisement content selected by the user from among the advertisement contents displayed on the display unit 140. The user inputs the order information through the UI.

That is, when a user selects one of advertisement contents displayed on the display unit 140 and makes an order for a product corresponding to the selected advertisement content, the order processing unit 133 provides a UI, such as a webpage, to allow the user to input order information for the product. Here, the purchase, the payment, and the distribution procedures for the product can be performed using the UI in association with the advertiser terminal 400.

In one general aspect, the advertisement selection unit 131 may be configured to select advertisement contents by further taking into account user request information. To this end, the UE 100 may further include an input unit 150 for input of the user request information.

In the current exemplary embodiment, the user selection unit 131 selects the advertisement contents by further taking into account the user request information, such as time information, priority information, and classification information, which is input by the user directly, as well as the user setting information including the age, gender, and interests of the user.

In another general aspect, the advertisement selection unit 131 may be configured to further take into account the user location information to select the advertisement contents. To this end, the user terminal 100 may further include a location information detection unit 160 for detecting the user location.

For example, the location information detection unit 160 may employ a GPS transmission/reception module to receive a GPS signal and detect a location of a UE 100.

Accordingly, the advertisement selection unit 131 may provide location-based personalized advertisement contents to the user using the location information detected by the location information detection unit 160, as well as the user setting information including the age, gender, and interests of the user.

In one general aspect, the control unit 130 may be configured to receive user setting information and advertisement meta-information periodically through the communication unit 110 and store the received information in the storage unit 120.

Unlike the above embodiment, the control unit 130 may be configured to sporadically receive advertisement meta-information related to a real-time advertisement event from the communication unit 110 when the real-time advertisement event occurs.

Accordingly, the UE 100 receives the user setting information and the advertisement meta-information from the advertisement service server 200 for the selection of the personalized advertisement contents in real time or in non-real time, and stores the received information.

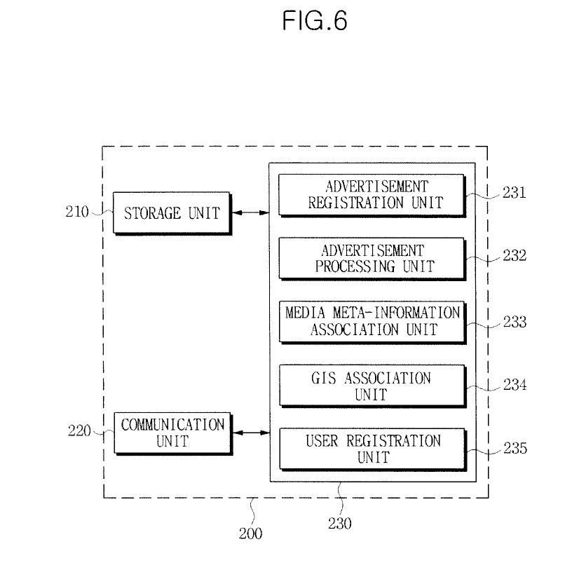

FIG. 6 is a block diagram illustrating an advertisement service server 200 for bidirectional personalized advertisement according to an exemplary embodiment. As shown in FIG. 6, the advertisement service server 200 for the bidirectional personalized advertisement includes a storage unit 210, a communication unit 220, and a control unit 230.

The storage unit 210 stores user setting information, advertisement meta-information, and advertisement contents. The storage unit 210 may physically or logically distribute and store the user setting information, the advertisement meta-information, and the advertisement contents.

The communication unit 220 transmits at least one of the user setting information, the advertisement meta-information, and the advertisement contents to a UE in real time or in non-real time.

For example, as shown in FIG. 3, the advertisement meta-information and the advertisement contents may be transmitted periodically according to advertisement update cycle information indicating a cycle of updating advertisement on a screen and meta-information update cycle information indicating a cycle of transmitting the advertisement meta-information, the advertisement update cycle information and the meta-information update cycle information included in the user setting information.

The user setting information may be transmitted sporadically, only when it is changed. The advertisement meta-information may be transmitted sporadically when an advertisement event occurs in the UE.

The control unit 230 controls the advertisement service server 200, and includes an advertisement registration unit 231. The advertisement registration unit 231 provides the advertiser terminal 400 (referring to FIG. 1) with a UI for registration of advertisement meta-information and advertisement contents, and stores the advertisement meta-information and the advertisement contents received through the UI into the storage unit 210.

Hence, the advertisement service server 200 provides the UE with the user setting information, the advertisement meta-information, and advertisement contents periodically or sporadically, and the UE which receives the pieces of information and advertisement contents uses the information to provide the user with personalized advertisement contents in real time or in non-real time without being dependent on a particular media service.

In one general aspect, the control unit 230 may further include an order processing unit 232. The order processing unit 232 provides a UI to the UE in response to a request from the UE such that the UE can input order information for a product corresponding to specific advertisement through the UI.

Therefore, in the current exemplary embodiment, when the user selects a specific advertisement from the advertisement contents displayed through the UE and makes an order request corresponding to the selected advertisement content, the order processing unit 232 provides a UI to the UE such that the user can order a corresponding product using the UI such as a webpage for inputting the order information for the product. In this case, the purchase, the payment, and the distribution procedures for the product can be performed using the UI in association with the advertiser terminal 400.

In another general aspect, the control unit 230 may further include a media meta-information association unit 233. The media meta-information association unit 233 associates the advertisement meta-information with media meta-information from the media service server 500 (referring to FIG. 1).

The control unit 230 may further include a GIS information association unit 234. The GIS information association unit 234 associates the advertisement meta-information with GIS information from a geographical information system 600 (see FIG. 1).

Accordingly, a composite advertisement can be provided by the association of the various existing IP network-based services such as media services and geographical information services, and more specifically, a personalized advertisement service can be provided to a user in real time or in non-real time without being dependent on a particular media service.

In addition, the control unit 230 may produce new extra services by combining a voice over IP (VoIP) service, a presence service and a connection service between a mobile phone and a landline phone using a public switched telephone network (PSTN) gateway.

The control unit 230 may further include a user registration unit 235, which is configured to register user setting information.

For example, the user registration unit 235 may be configured to provide a UI to the UE for the user setting information registration such that the user setting information input through the provided UI is stored in the storage unit 210.

Alternatively, the user registration unit 235 may be configured to receive the user setting information from a subscriber manager that manages information of network subscribers and store and register the received user setting information into the storage unit 210.

For example, subscriber information is received as user setting information from an HSS that manages service profiles required for registration of subscriber and providing of services in an IMS network, and is stored and registered in the storage unit 210.

That is, in the current exemplary embodiment, the advertisement service server 200 uses the user registration unit 235 to automatically or manually obtain and store the user setting information which is taken into account when the UE selects the personalized advertisement contents.

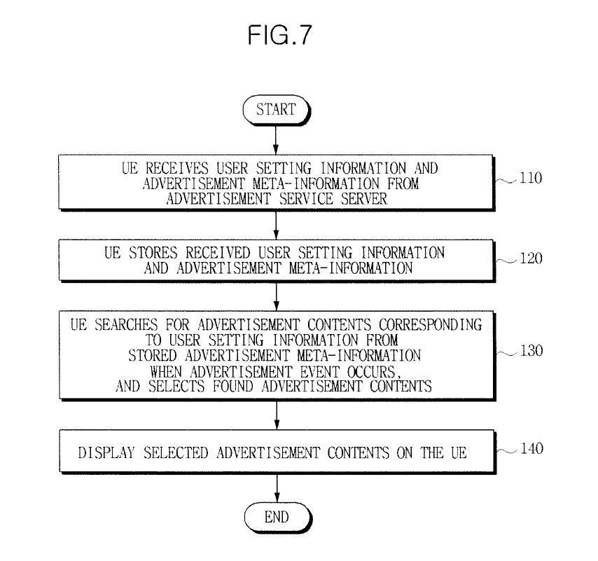

Procedures of a bidirectional personalized advertisement service between the UE and advertisement service server, whose configurations are described above, will be described with reference with FIG. 7. FIG. 7 is a flowchart illustrating a bidirectional personalized advertisement method of a UE.

As shown in FIG. 7, the UE receives user setting information and advertisement meta-information from the advertisement service server (operation 110).

Then, the UE stores the received user setting information and advertisement meta-information (operation 120).

The UE selects advertisement contents corresponding to the user setting information from the stored advertisement meta-information when an advertisement event occurs (operation 130).

For example, the advertisement event may be an advertisement request from a user, or an advertisement request automatically generated due to the use of a web service or a media service.

The UE displays the selected advertisement contents. At this time, the UE may request the advertisement service server for real-time transmission of the selected advertisement contents to display the advertisement contents in real time.

Alternatively, the UE may read out the selected advertisement contents from a database storing advertisement contents to display the selected advertisement contents in non-real time.

Accordingly, the personalized advertisement contents are selected based on the advertisement meta-information and the user setting information, and hence the dependence of online advertisement service on a particular media service can be solved.

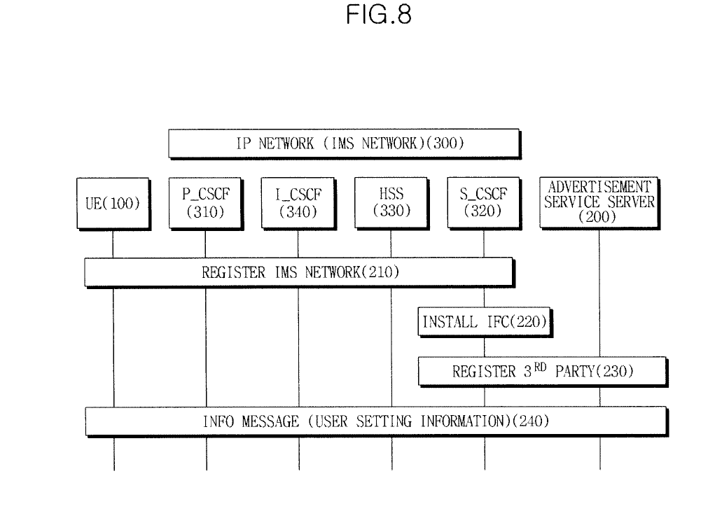

FIG. 8 is a flowchart illustrating procedures of providing user setting information to a UE 100 from the advertisement service server 200 via an IMS network 300.

The UE 100 registers with the IMS network 300 according to standard IMS registration (operation 210). Then, an S-CSCF 320 of the IMS network installs initial filter criteria (iFC) information of a corresponding user which is received from an HSS 330 (operation 220).

The S-CSCF 320 performs 3^{rd}-party registration on the advertisement service server 200 according to the iFC information (operation 230). For this operation, a REGISTER message of IMS is used, and identification information and authentication information of the UE 100 are transferred to the advertisement service server 200. After the registration is completed, the advertisement service server 200 transmits the user setting information contained in an INFO message of the IMS to the UE 100 (operation 240).

Consequently, the advertisement service server 200 provides the UE 100 with the user setting information via the IMS network 300 that is an IP network.

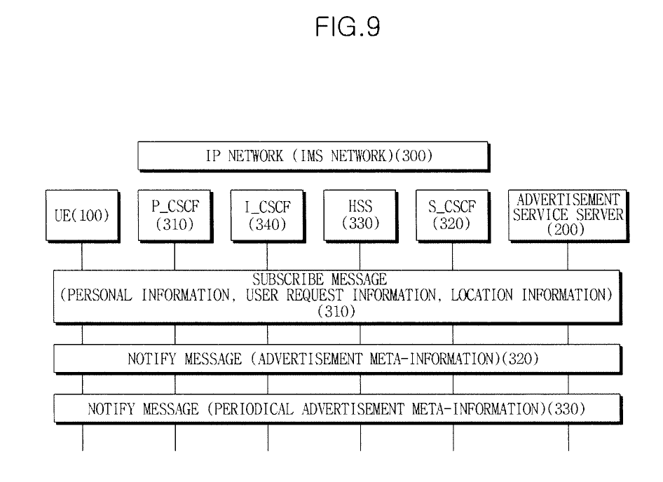

FIG. 9 is a flowchart illustrating procedures of providing advertisement meta-information to the UE 100 from the advertisement service server 200 via the IMS network 300.

When the UE 100 receives the user setting information contained in the INFO message, the UE 100 transmits a SUBSCRIBE message to the advertisement service server 200 in order to receive the advertisement meta-information (operation 310). The SUBSCRIBE message may include personal information of a user, user request information, and user location information.

The service server 200 includes the advertisement meta-information in a NOTIFY message of the IMS by using the information included in the SUBSCRIBE message, and the NOTIFY message including the advertisement meta-information to the UE 100 (operation 320).

Thereafter, the advertisement service server 200 periodically includes the advertisement meta-information in the NOTIFY message and transmits the NOTIFY message to the UE 100 according to meta-information of the update cycle information (operation 330).

Thus, the advertisement service server 200 provides the UE 100 with the advertisement meta-information through the IMS network 300 that is the IP network 300.

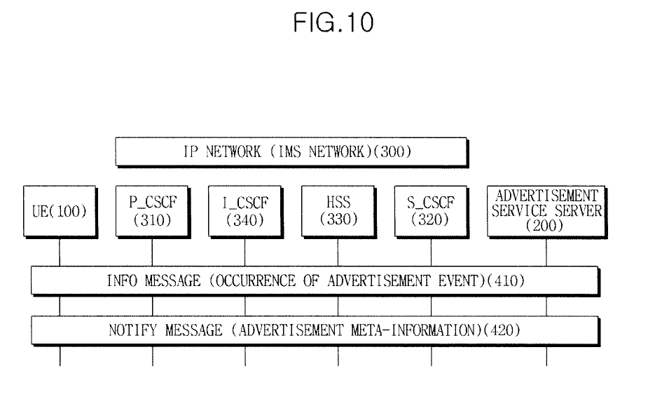

FIG. 10 is a flowchart illustrating procedures of receiving advertisement meta-information by the UE 100 from the advertisement service server 200.

The UE 100 may voluntarily request the advertisement service server 200 to provide advertisement meta-information, instead of waiting for periodical advertisement meta-information, when a real-time advertisement event such as location information detected by a GPS transmission/reception module and the like, which is required to be performed in real-time, takes place.

To this end, the UE 100 uses the INFO message to notify the advertisement service server 200 of the occurrence of a real-time advertisement event (operation 410).

Then, the advertisement service server 200 immediately selects the advertisement meta-information, and transmits the selected meta-information using the NOTIFY message to the UE 100 (operation 420).

Accordingly, the advertisement service server 200 provides the UE 100 with the advertisement meta-information through the IMS network 300 that is an IP network in real time.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user equipment (UE) for bidirectional personalized advertisement, comprising:
a communication unit to receive user setting information and advertisement meta-information from an advertisement service server;
a storage unit to store the received user setting information and advertisement meta-information;
a control unit to control the UE, the control unit including an advertisement selection unit which searches for advertisement contents corresponding to the user setting information from the advertisement meta-information stored in the storage unit and selects the found advertisement contents when an advertisement event occurs; and
a display unit to display the selected advertisement contents.

2. The UE of claim 1, wherein the control unit further comprises an advertisement execution unit to request the advertisement service server for real-time transmission of the advertisement contents selected by the advertisement selection unit and to control the display unit to display the selected advertisement contents in real time.

3. The UE of claim 1, wherein the control unit further comprises an advertisement execution unit to read out the selected advertisement contents from the storage unit previously storing advertisement contents and to control the display unit to display the selected advertisement contents in non-real time.

4. The UE of claim 1, wherein the control unit further comprises an order processing unit to request the advertisement service server for a user interface (UI) which allows a user to input order information for a product corresponding to the advertisement content selected by the user from among the advertisement contents displayed on the display unit, and to input the order information through the requested UI.

5. The UE of claim 1, wherein the advertisement selection unit selects the advertisement contents by further taking into account user request information.

6. The UE of claim 5, further comprising an input unit through which the user request information is input.

7. The UE of claim 1, wherein the advertisement selection unit selects the advertisement contents by further taking into account user location information.

8. The UE of claim 7, further comprising a location information detection unit to detect the user location information.

9. The UE of claim 1, wherein the control unit periodically receives the user setting information and the advertisement meta-information through the communication unit and stores the received user setting information and advertisement meta-information into the storage unit.

10. The UE of claim 1, wherein the control unit receives advertisement meta-information related to a real-time advertisement event sporadically through the communication unit when the real-time advertisement event occurs.

11. An advertisement service server for bidirectional personalized advertisement, comprising:
a storage unit to store user setting information, advertisement meta-information, and advertisement contents;
a communication unit to transmit at least one of the user setting information, advertisement meta-information, and advertisement contents to a user equipment (UE) in real time or in non-real time; and
a control unit to control the advertisement service server, the control unit including an advertisement registration unit which provides an advertiser terminal with a user interface (UI) for registration of advertisement meta-information and advertisement contents and stores the advertisement meta-information and the advertisement contents input through the UI into the storage unit.

12. The advertisement service server of claim 11, wherein the control unit further comprises an order processing unit to provide a UI to the UE in response to a request from the UE such that the UE can input order information of a product corresponding to a specific advertisement content through the UI to the order processing unit.

13. The advertisement service server of claim 11, wherein the control unit further comprises a media meta-information association unit to associate the advertisement meta-information with media meta-information of a media service server.

14. The advertisement service server of claim 11, wherein the control unit further comprises a global information system (GIS) information association unit to associate the advertisement meta-information with GIS information.

15. The advertisement service server of claim 11, wherein the control unit further comprises a user registration unit to register the user setting information.

16. The advertisement service server of claim 15, wherein the user registration unit provides a UI to the UE for registering the user setting information and registers the user setting information input through the provided UI by storing it into the storage unit.

17. The advertisement service server of claim 15, wherein the user registration unit receives the user setting information from a subscriber manager, which manages information of network subscribers, and registers the received user setting information by storing it into the storage unit.

18. A bidirectional personalized advertisement method of a user equipment, the method comprising:
receiving user setting information and advertisement meta-information from a advertisement service server;
storing the received user setting information and advertisement meta-information;
searching for advertisement contents corresponding to the user setting information from the stored advertisement meta-information and selecting the found advertisement contents when an advertisement event occurs; and
displaying the selected advertisement contents.

19. The method of claim 18, wherein the display of the advertisement contents comprises requesting the advertisement service server for real-time transmission of the selected advertisement contents and displaying the selected advertisement contents input from the advertisement service server in real time.

20. The method of claim 18, wherein the displaying of the selected advertisement contents comprises reading out the selected advertisement contents from a database previously storing advertisement contents and displaying the read out advertisement contents in non-real time.
